(19) United States
(12) Patent Application Publication
(10) Pub. No.: US 2010/0101277 A1
(43) Pub. Date: Apr. 29, 2010

(54) METHOD OF FUSING OPTICAL FIBERS WITHIN A SPLICE PACKAGE

(76) Inventors: Francois Gonthier, Quebec (CA); Eric Weynant, Quebec (CA)

Correspondence Address: DAY PITNEY LLP, 7 TIMES SQUARE, NEW YORK, NY, 10036-7311, US

(21) Appl. No.: 12/593,467

(22) PCT Filed: Mar. 28, 2008
(86) PCT No.: PCT/CA08/00593

§ 371 Date: Sep. 28, 2009

Related U.S. Application Data
(60) Provisional application No. 60/908,421, filed on Mar. 28, 2007.

(51) Int. Cl. B29D 11/00; C03B 37/15

(52) U.S. Cl. 65/392; 264/1.27

(57) ABSTRACT

The present invention relates to methods of connecting optical fibers. In a first aspect, the method proceeds by using a ferrule device having a passage adapted to apply radial pressure to optically align and hold in position opposed fiber ends, and fusing said fiber ends held by said ferrule device. In another aspect, the method of the present invention uses a ferrule device to optically align without mechanized adjustment and hold in position opposed fiber ends with a gap where said fiber ends meet, where the fibers have a temperature of fusion that is higher than a melting temperature of said ferrule device. The method then transmits radiation directly onto said fiber ends without significant direct transmission onto said ferrule device to generate heat in said fiber ends and fuse said fiber ends held by said ferrule device.

### FIELD OF THE INVENTION

This invention relates to splicing and fusing optical fibers. The invention relates to the splicing package and mechanical splices for connecting optical fibers. Furthermore, this invention relates to protecting the splice for external strain and for high power losses. This invention also relates to the splicing and fusion processes of optical fibers and a method for doing this within the splice package.

### BACKGROUND OF THE INVENTION

Optical fibers are used in many applications, from telecommunications systems to sensors, medical equipment and lasers. To build these systems, optical fiber must be connected or spliced together as to permit the transmission of light from one part of the system to another. The most permanent connections are made by fusion splicing together of the fibers. The glass or plastic fibers must be melted so that the two fibers ends are fused together. The fused splice is done with a fusion splicer. They are of two types. Conventional splicers that give the best splice performance have motorized mechanical alignment fixtures to optimize the transmission between the fibers. The other ones have pre-aligned grooves and rely on the fiber geometrical parameters for the alignment. Optical fibers, such as the ones used in telecommunication systems, have very good and well-controlled parameters such as core diameter, ellipticity and eccentricity so that pre-aligned fusion splicers do very good splices, but they cannot compensate for small misalignments occurring during fusion. The heat of fusion causes some deformation of the fiber ends that can cause such small misalignments.

Once a fusion splice is made, it has to be protected in some way from external forces that could bend or pull on the fiber to a breaking point. The splice area usually has a low mechanical strength in comparison with the pristine fiber. This is usually done by recoating the splice area, or by encapsulating it in a splice package. Splice packages can vary from very simple, such as placing the spliced area in a thermo-plastic shrink sleeve in parallel with a metal rod, to more complex packages such as gluing the splice area to a substrate and encapsulating the substrate. The level of packaging is determined by the resistance requirements of the splice, such as high mechanical strength or high power handling. Splices are used when the connection is permanent or the optical losses have to be minimal. Other connection technologies such as mechanical splices or connectors may have higher losses but can be disconnected.

There exists many standards for connectors, but they all achieve the same function. The fiber end is inserted in a ferrule and is glued in place. The connector has mechanical features that allow it to be attached to the receptacle which can contain a component such as a laser or a detector, other output optics or another connector. The purpose of connectors is to align the fiber end to the other device or fiber. Because connectors have to slide in the receptacle, there is always some misalignment because of tolerances, thus higher losses. Furthermore, connectors are bulkier than splices and when fiber ends do not need to be handled after the connection, or the space available is too small, mechanical splices can be used.

They most often take the form of a cylinder with a feed-through passageway where the fiber can be inserted at both end. The passageway enables the fiber ends to be place in contact in front of each other thus connecting them. To improve the connection and the sliding of the fibers in the passageway, the latter it shaped with conical ends and it is pre-filled with index matching gel or oil. As with the connectors, because of the tolerances, the alignment is not a good as using a fusion splicer. Furthermore, the fiber must be secured to the mechanical splice to prevent them from being pulled out during handling. One can bond them or use some sort of external clamping scheme.

To improve mechanical splices, Demissy et al. in U.S. Pat. No. 7,066,656 have demonstrated the use of a memory shape alloy that can be used to fabricate mechanical splices with extremely tight tolerances. The mechanical splice is a ferrule with a feed-through passageway that is within 1 micron of the fiber diameter. The fiber cannot actually be fed through the ferrule. However, the alloy can be plastically open by properly applying strain, the fibers can be inserted. When the stain is released, the alloy holds tight the fibers in place with excellent alignment, thus providing connection almost as good as fusion splices.

These improved splices however, though the fibers are held in a much tighter manner than previous mechanical splices, still suffer from the fact the fibers have to be secured to the splice to achieve the same pull strength as a good fusion splice. Furthermore, there can also be a small gap between the fibers that might open due to temperature variations, thus affecting the quality of the connection. This is an issue for the long-term performance of the splice.

### SUMMARY OF THE INVENTION

It is an object of the present invention to use a mechanical splice to align fiber ends to permit transmission of the light between the fibers while the fibers are bonded or fused together.

The purpose of this invention is to overcome these drawbacks for permanent mechanical splices. In this invention, the mechanical splice is used to align the fibers, but the fibers are then fused together, rather than leaving them solely supported by the mechanical splice. This is achieved by heating the mechanical splice to a temperature at which the fibers fuse. This can be done easily with low temperature melting point fibers such as plastic fibers, fluoride or chalcogenide glass fiber. For silica fibers, the melting point is most likely above the melting point of the ferrule material, and the heat needs to be delivered to the mechanically aligned fiber ends without adversely affecting the ferrule. In some embodiments, a hole is micro-machined perpendicular to the feed-trough passageway at the position were the fibers joint in the middle of the ferrule. This gives access to fusing the two fiber ends using a local heat source, such as a CO₂ laser. The hole must be large enough so that the heat generated during the fiber end fusing process does not damage the ferrule. The mechanical splice can remain in place and thus serve as a splice protection package.

In some embodiments, the mechanical splice is a ferrule with a passageway with very tight tolerances as to minimize misalignment.

In some embodiments, the ferrule can be mechanically opened by expanding the passageway, closing it on the fibers once the fibers are inserted, holding the fibers in a precise position to optimize the transmission of light.

In some embodiments, the ferrule is a metal ferrule.

In some embodiments, the ferrule is made of copper or a copper-based memory shape alloy that conducts heat.

In some embodiments, the fibers can be fused together by heating the ferrule if the fibers have a lower melting point that the ferrule material and if the ferrule material has a small thermal expansion coefficient, so that that the misalignment at the melting point of the fibers is small.

In some embodiments, the ferrule may have an access hole crossing the passageway to provide access to the fiber ends.

In some embodiments, the fibers can be bonded using a transparent liquid bonding material injected though the access hole.

In some embodiments, the fibers ends can be fused by providing a localized heat source though the access hole.

In some embodiments, the fiber fusion heat source providing heat through an access hole in the ferrule is a laser, such as a CO₂ laser.

In some embodiments, the splice is annealed by heating the splice area at a lower temperature than the fusion temperature.

In some embodiments, the access hole is large enough such that the heat generated on the fibers and being conducted though the fibers during the fusion process does not damage the ferrule, even if the fibers have a much higher melting point than the ferrule.

In some embodiments, the ferrule material has a very high thermal conductivity so that the hole can be as small as possible while fusion heat is conducted away into the ferrule without melting the ferrule material.

In some embodiments, the mechanical splice stays in place after the fusion to act as a splice protection package and to provide additional mechanical strength.

In some embodiments, the ferrule can be covered by a protective sleeve to prevent bend the fibers at the exits of the ferrule.

### BRIEF DESCRIPTION OF THE DRAWINGS

The invention will be better understood by way of the following detailed description with reference to the appended drawings, in which:

FIG. 1a is a perspective, break-away view of fiber ends mechanically coupled in a ferrule having a cylindrical channel containing the fiber ends for mechanical splicing;

FIG. 1b is a perspective view of fiber ends mechanically coupled in a V-groove;

FIG. 2 is a perspective, break-away view of fiber ends mechanically coupled in a shape memory alloy ferrule adapted to take a first shape or forced open to allow the fiber ends to move within the channel and to take a second shape or be relaxed (as shown) to spring closed to grip the fiber ends with radial force to center and hold the fiber ends in optical alignment;

FIG. 3 is a perspective, break-away view of the ferrule of FIG. 2 modified to have a central radial access hole for allowing laser radiation to pass and be absorbed by the fiber ends for fusion to take place, the hole providing a suitable size gap to allow the fiber ends to reach fusion temperatures without heating the ferrule above its melting point;

FIG. 4 is a schematic diagram showing a laser beam focused to pass through the central radial access hole of the ferrule of FIG. 3; and

FIG. 5 is a schematic longitudinal sectional view of a ferrule similar to the ferrule of FIG. 3 adapted to hold a fiber jacket of each fiber end.

### DETAILED DESCRIPTION OF THE INVENTION

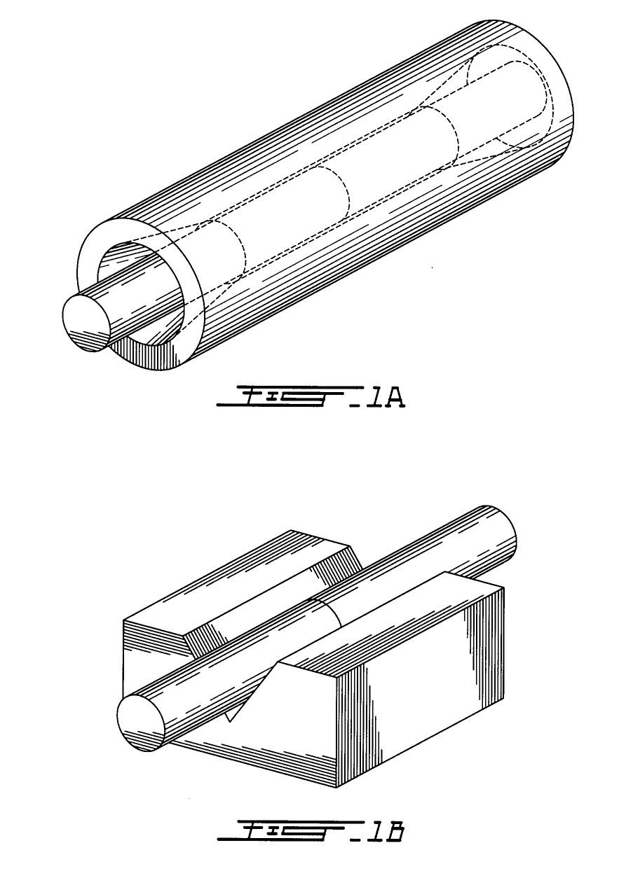

Mechanical fiber optic splices are ferrules or V-grooves as shown in FIGS. 1 a and b respectively. The cylindrical fiber receiving passage in FIG. 1a is shown open and can be closed by mechanical action. The alignment using V-grooves can be very precise, leaving error strictly due to fiber tolerances such as core diameter, cladding diameter, core eccentricity, and core ellipticity. The present quality of the fibers makes it possible to achieve very good transmission (better than 0.1 dB optical loss) by passive alignment in V-grooves. Low cost splicing equipment, i.e. equipment without mechanized alignment, uses V-grooves to prealign the fiber ends before fusion. However, the quality of fusion for those machines is lesser than for the mechanized alignment machine because, not one but two prealigned V-grooves must be used, and they are typically more than 1 cm apart. Thus, there can be misalignment errors. Furthermore, the fibers must be held in the V-grooves with mechanical clamps, which must apply pressure on the fibers to keep them in place. This pressure is not symmetric and can cause some strain in the fibers, affecting the alignment during the fusion.

The fusion itself may create some force on the splice region because of surface tension. The fibers being held away from the splice region, misalignment may occur. The lateral position of fibers being fixed by the V-groove, the splice loss can be reduced only by increasing fusion time. Overall however, splices with V-groove machines are worse than mechanized alignment machines. For mechanical splices, the issues are similar, being mainly related to the fiber clamp being required to hold the fiber in the V-groove and the pressure that must be exerted to maintain the fibers in place.

When mechanical splices use ferrules, the issue of clamping only arises to maintain the fibers in the ferrule. This does not generally create problems of strain on the fibers in the ferrules. The issue here is simply that tolerances of a few microns (typically 5 μm) are required to enable the insertion of the fibers in the ferrule, creating therefore some misalignment of the fibers.

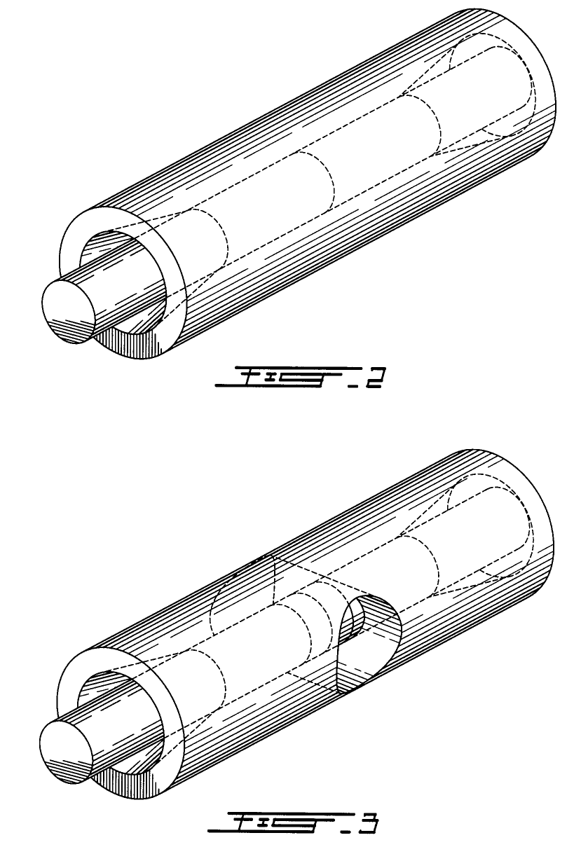

To resolve this alignment issue, but also to address the clamping of the fibers U.S. Pat. No. 7,066,656 to Demissy et al., describes a ferrule, where the hole can be opened to allow the fibers to be inserted and then closed to hold the fibers in place without alignment tolerance problems. This ferrule holding the fibers is illustrated in FIG. 2. However, even without alignment error, the mechanical splice is sensitive to the quality of the fiber ends, which are normally cleaved. Imperfection in the cleaves creates air-gaps which affect the quality of the coupling. Furthermore, if the fibers are pulled longitudinally, they may slip within the mechanical splice, thus creating an air-gap.

To make this splice permanent, to increase its pull strength and to remove the air gaps due to imperfect cleave angles, the fibers are fused while held within the ferrule. The fusion process will close the air gaps and solidify the splice so that it cannot misalign if the splice sees temperature changes or the fibers are pulled.

If the fibers are plastic and low melting temperature glass, it is possible to do this by heating the ferrule to the melting point of the fiber. This will not work however if the fiber a silica fiber and the ferrule is made of a copper alloy as per U.S. Pat. No. 7,066,656 to Demissy et al.

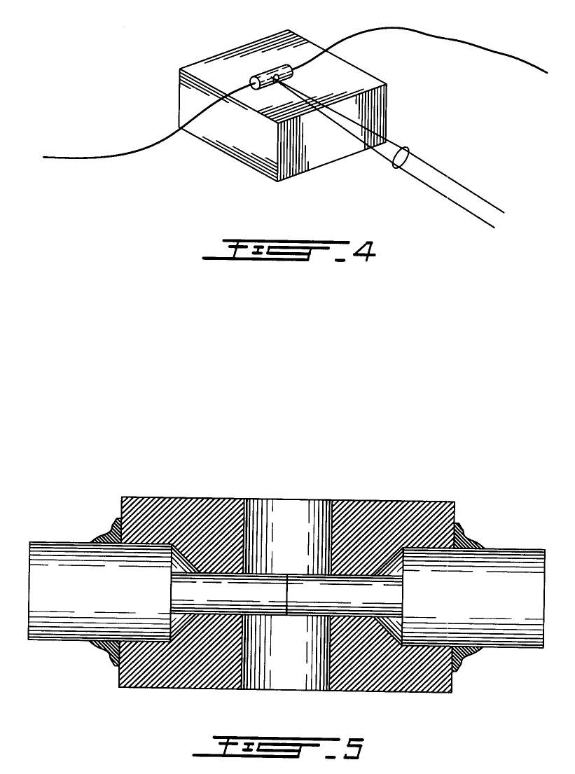

Thus it is an embodiment of this invention to modify the ferrule by machining an access hole to cross the ferrule passageway at the splice point, as illustrated in FIG. 3. This access hole can than be used to heat to fiber with a point heat source such as a CO₂ laser as illustrated in FIG. 4. This has the advantage of heating only the fiber without heating directly the ferrule, preventing it from melting. Only reflected and scattered light from the CO₂ laser hits the ferrule. This represents only a few percent of the heat. The fiber will heat the ferrule by radiation and conduction through the air but also mainly through conduction longitudinally though the fiber. To prevent this longitudinal conduction of heat and resulting damage the ferrule, the access hole can be made to be more than twice the fiber diameter. Furthermore, if the ferrule is made of a highly thermally conductive material, such as copper or copper alloys, it will take more time to heat the fiber ends to their melting point.

In this embodiment, the fiber ends are held at close proximity of the fused region preventing any movement of the fiber during fusion thus limiting any misalignment that can happen using fusion splicers that hold the fibers typically more than 1 cm away. Any air gap is filled thus improving transmission of light. This enables to obtain a splice quality equivalent to the quality obtain with machines with mechanized alignment. In other words, the deviation from pre-fusion optimal fiber end alignment that may arise using a ferrule instead of a mechanized alignment system is readily compensated on average by holding the fiber ends much more closely to the fusion region so as to reduce the misalignment that arises during fusion. For silica fibers and the like having high fusion temperatures, the delivery of the heat by a beam of radiation allows the required heat to be delivered directly to the fiber ends without adversely affecting the ferrule or mechanical splice.

Furthermore, once the fiber ends are fused, the area surrounding the fusion can be heated to a lower temperature to remove stresses induced by the strong temperature gradient during the fusion. For a silica fiber, this annealing is done around 600 to 700° C., which is lower than the melting point of the copper ferrule. The annealed region can thus cover the whole region of the fibers exposed by the access hole. This process increases the mechanical strength of the splice region.

It is thus possible to build a fusion splicing machine that uses a ferrule for the mechanical alignment and a CO₂ laser heat source or other laser wavelength that is absorbed by the fiber material. For standard fibers, because there is no alignment optimization process, the splice is made without measuring the transmission though the fiber. The access hole can be used not only to heat, but to observe the fusion process, with a microscope, or a visible or infrared camera, to determine if the cleave quality is good, or during fusion if some bubbles or other defects appear that would affect the quality of the splice. A second access hole can also be machined to permit better or another view on the fiber ends and the fusion process.

Once the fusion is finished, the ferrule acts immediately as a splice protection package, preventing any bending of the splice region that may cause it to break and furthermore gives the splice a stronger longitudinal resistance to traction, and increases its pull strength. The ferrule than be encapsulated by a thermo-plastic that can be shrunk onto the ferrule. This covers the access hole and gives some strength to the fiber exiting the ferrule, better protecting it from breaking when pulled sideways. This also can be achieved by gluing the fibers exiting the ferrule with silicone or a flexible epoxy. Alternatively, the ferrule can be made to hold the fiber jacket as illustrated in FIG. 5. The exiting fibers can be strengthened again by being bonded or by a plastic jacket. If no plastic jacket is used, the access hole can be sealed by drop of acrylate or bonding material or solder, to protect the splice area.

1. A method of connecting optical fibers comprising:
using a ferrule device having a passage adapted to apply radial pressure to optically align and hold in position opposed fiber ends; and
fusing said fiber ends held by said ferrule device.

2. The method as claimed in claim 1, wherein said fusing is carried out by transmitting radiation directly onto said fiber ends to heat said fiber ends.

3. The method as claimed in claim 2, wherein said fiber ends are each held by the ferrule device at a distance from an extremity of said fiber ends equal to about a diameter of said fiber end.

4. The method as claimed in claim 1, wherein said fusing is performed using a laser.

5. The method as claimed in claim 4, wherein said laser is a CO₂ laser.

6. The method as claimed in claim 1, wherein said ferrule device is made of a shape memory alloy material, said using said ferrule comprising expanding said passage, inserting said fiber ends into said passage, and causing said shape memory alloy material to collapse on said fiber ends, thus exerting said radial pressure.

7. The method as claimed in claim 6, wherein said ferrule device has at least one radial hole at a fusion region to allow for transmission of radiation onto said fiber ends and/or inspection of a fusion of said fibers.

8. The method as claimed in claim 1, wherein said ferrule device is used as a mechanical reinforcement to support a resulting fusion splice of said fiber ends, said ferrule device forming part of a packaging of a fiber connector.

9. A method of connecting optical fibers comprising:
using a ferrule device to optically align without mechanized adjustment and hold in position opposed fiber ends with a gap where said fiber ends meet;
said fibers having a temperature of fusion that is higher than a melting temperature of said ferrule device;
said gap being large enough to reduce heat transfer from said fibers to said ferrule device so that a heat of fusion does not compromise said ferrule device and small enough that a heat of fusion does not cause said fiber ends to become misaligned and impair an optical coupling between said fiber ends; and
transmitting radiation directly onto said fiber ends without significant direct transmission onto said ferrule device to generate heat in said fiber ends and fuse said fiber ends held by said ferrule device.

10. The method as claimed in claim 9, further comprising a step of transmitting radiation onto said fiber ends to cause annealing of said fibers at a temperature lower than a melting temperature of said ferrule device.

11. The method as claimed in claim 10, wherein said ferrule device is made of copper.

12. The method as claimed in claim 9, wherein said radiation is provided using a CO₂ laser.

13. A method of connecting optical fibers comprising:
using a ferrule device to optically align and hold in position opposed fiber ends;
fusing said fiber ends held by said ferrule device; and
using said ferrule device as a mechanical reinforcement to support a resulting fusion splice of said fiber ends, said ferrule device forming part of a packaging of a fiber connector.

14. A method of connecting optical fibers comprising:
using a ferrule device to optically align and hold in position opposed fiber ends;
fusing said fiber ends held by said ferrule device; and
annealing said fibers at a temperature lower than a melting temperature of said ferrule device.
